(19) United States
(12) Patent Application Publication
(10) Pub. No.: US 2011/0286699 A1
(43) Pub. Date: Nov. 24, 2011

(54) LIGHT GUIDE BODY AND LIGHTING APPARATUS HAVING THE SAME

(75) Inventors: Takafumi SANADA, Fukuoka (JP); Kohei SUYAMA, Kumamoto (JP); Yuuzou KAWANO, Fukuoka (JP)

(73) Assignee: PANASONIC CORPORATION, Osaka (JP)

(21) Appl. No.: 13/114,161

(22) Filed: May 24, 2011

(30) Foreign Application Priority Data
May 24, 2010 (JP) 2010-117908

(51) Int. Cl. G02B 6/34; G02B 6/26

(52) U.S. Cl. 385/36; 385/43

(57) ABSTRACT

The present invention provides a light guide body that has a light incidence portion through which light enters the light guide body; a light reflecting portion positioned opposite a light emitting surface that extends from the light incidence portion in a longitudinal direction of the light guide body; and a tapered portion having an inner surface that gradually expands from the light incidence portion toward the light reflecting portion. The tapered portion has a light shielding portion to shield, from the light, a part of the light reflecting portion closest to the light incidence portion.

### CROSS-REFERENCE TO RELATED APPLICATIONS

The present application claims priority under 35 U.S.C. §119 of Japanese Application No. 2010-117908, filed on May 24, 2010, the disclosure of which is expressly incorporated by reference herein in its entirety.

### BACKGROUND OF THE INVENTION

1. Field of the Invention

The present invention relates to a light guide body that guides a light within the light guide body and emits the light from its light emitting surface extending in a longitudinal direction. The present invention also relates to a lighting apparatus that has the light guide body.

2. Description of Related Art

In a document scanning apparatus to scan an image on a document surface, a scanning sensor provided with a light receiving element, such as a CCD, receives light reflected on a document surface illuminated by a lighting apparatus that extends in a main-scanning direction, and outputs an image signal detected by the scanning sensor. Conventionally, it is common for such a lighting apparatus of a document scanning apparatus to use a fluorescent tube such as a CCFL (cold cathode fluorescent lamp) and the like. In recent years, however, it is getting popular that an LED is used as a light source in terms of energy saving. Incidentally, a main-scanning direction refers to a direction perpendicular to a direction in which a document, a lighting apparatus or a scanning sensor moves, when a document scanning apparatus scans a document. A sub-scanning direction refers to a direction in which a document, a lighting apparatus or a scanning sensor moves, when a document scanning apparatus scans a document.

Such a lighting apparatus using an LED as a light source employs a configuration in which light generated from an LED, serving as a point light source, is guided toward a document surface by using a tubular light guide body that extends over an entire width of an area to be scanned. In the light guide body, a light reflecting portion, configured by prisms, is provided in a position opposing a light emitting surface, to cause light generated by the LED to enter a light incidence surface on one side of a longitudinal direction and exit from a light emitting surface extending in the longitudinal direction (See Related Art 1).

There is also disclosed a technology in which a coupling section, having a tapered shape, is provided between a light source and a light reflecting portion to transmit light to the light reflecting portion while controlling eclipse, which is a drop in a peripheral brightness on a light incidence surface, so that light from the light source can be introduced into the light guide body efficiently (See Related Art 2).

In the configuration illustrated in Related Art 2, however, light is directly radiated and reflected onto a prism (slit) closest to a light source and exits. The illuminance of such light, in which the light path length is short and no attenuation occurs, is high. In the illuminance distribution of the main-scanning direction in this instance, there is a great difference between illuminance on a side closer to the light source and illuminance on a side spaced from the light source. Such great illuminance variation is not preferable in terms of the product quality.

Related Art 1: Japanese Patent Application Publication No. 2001-61040

Related Art 2: Japanese Patent Application Publication No. 2008-270885

### SUMMARY OF THE INVENTION

The present invention addresses such circumstances, and an objective of the present invention is to provide a light guide body without large illuminance variation and a lighting apparatus that includes the light guide body.

According to an aspect of the present invention, a light guide body has a light incidence portion through which light enters the light guide body; a light reflecting portion positioned opposite a light emitting surface that extends from the light incidence portion in a longitudinal direction of the light guide body; and a tapered portion having an inner surface gradually expands from the light incidence portion toward the light reflecting portion. The tapered portion has a light shielding portion to shield, from the light, a part of the light reflecting portion closest to the light incidence portion.

By providing the light shielding portion, the present invention makes it possible to prevent light from being radiated directly onto a part of the light reflecting portion closest to the light source. With this configuration, it is possible to control light, in which the light path length is small and no attenuation occurs, from being emitted from the light emitting surface. Thus, by reducing the illuminance in the vicinity of the light source, it is possible to prevent large illuminance variation in the main-scanning direction from occurring.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic cross-sectional view illustrating a lighting apparatus to which the present invention is applied;

FIG. 2 is a perspective view of the lighting apparatus illustrated in FIG. 1 seen from the direction of arrow II in FIG. 1;

FIG. 3 is a perspective view of a tapered portion of a light guide body illustrated in FIG. 2 seen from the direction of arrow III in FIG. 2;

FIG. 4 is an enlarged cross-sectional view explaining a function of an example according to a first embodiment;

FIG. 5 is an enlarged cross-sectional view explaining a function of a reference example according to a conventional technology;

FIG. 6 shows an illuminance distribution in the main-scanning direction of the example and the reference example;

FIG. 7 shows an illuminance distribution in the sub-scanning direction of the example;

FIG. 8 shows an illuminance distribution in the sub-scanning direction of the reference example;

FIG. 9 is a perspective view of a lighting apparatus of another example according to the first embodiment;

FIG. 10 is a perspective view of a tapered portion of a light guide body illustrated in FIG. 9 seen from the direction of arrow X in FIG. 9;

FIG. 11 is an enlarged cross-sectional view explaining an operation of another example according to the first embodiment;

FIG. 12 shows an illuminance distribution in the main-scanning direction of the other example, the reference example, and the example;

FIG. 13 is an enlarged cross-sectional view of prisms of FIG. 11;

FIGS. 14(a) to 14(c) are each a schematic cross-sectional view illustrating the cross-sectional shape of the prisms, and trajectories of light reflected on the prisms;

FIGS. 15(a) and 15(b) are each a chart showing a comparison between an illuminance distribution in the main-scanning direction of the prisms illustrated in FIGS. 14(a) to 14(c) and an ideal illuminance distribution;

FIGS. 16(a) and 16(b) are each a schematic cross-sectional view illustrating the cross-sectional shape of the prisms, and trajectories of light reflected on the prisms;

FIGS. 17(a) and 17(b) are each a chart showing a comparison between an illuminance distribution in the main-scanning direction of the prisms illustrated in FIGS. 16(a) and 16(b) and an ideal illuminance distribution;

FIGS. 18(a) and 18(b) are each a schematic cross-sectional view illustrating the cross-sectional shape of the prisms, and trajectories of light reflected on the prisms;

FIGS. 19(a) and 19(b) are each a chart showing a comparison between an illuminance distribution in the main-scanning direction of the prisms illustrated in FIGS. 18(a) and 18(b) and an ideal illuminance distribution;

FIGS. 20(a) to 20(c) are each a schematic cross-sectional view illustrating the cross-sectional shape of the prisms, and trajectories of light reflected on the prisms;

FIGS. 21(a) and 21(b) are each a chart showing a comparison between an illuminance distribution in the main-scanning direction of the prisms illustrated in FIGS. 20(a) to 20(c) and an ideal illuminance distribution;

FIGS. 22(a) to 22(c) are each a cross-sectional view explaining displacement between the light guide body axis and the light source axis;

FIG. 23 shows illuminance distribution in the main-scanning direction of the reference example according to the conventional technology with respect to displacement of the optical axis;

FIG. 24 is a perspective view illustrating a main part of an example according to a second embodiment;

FIG. 25 is an enlarged cross-sectional view of FIG. 24;

FIG. 26 is a perspective view illustrating a main part of another example according to the second embodiment;

FIGS. 27(a) and 27(b) are each an enlarged cross-sectional view of FIG. 26;

FIG. 28 shows an illuminance distribution in the main-scanning direction of the example according to the second embodiment with respect to displacement of the optical axis; and

FIG. 29 shows an illuminance distribution in the main-scanning direction of another example according to the second embodiment with respect to displacement of the optical axis.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

First Embodiment

Hereinafter, a first embodiment of the present invention will be explained with reference to the drawings.

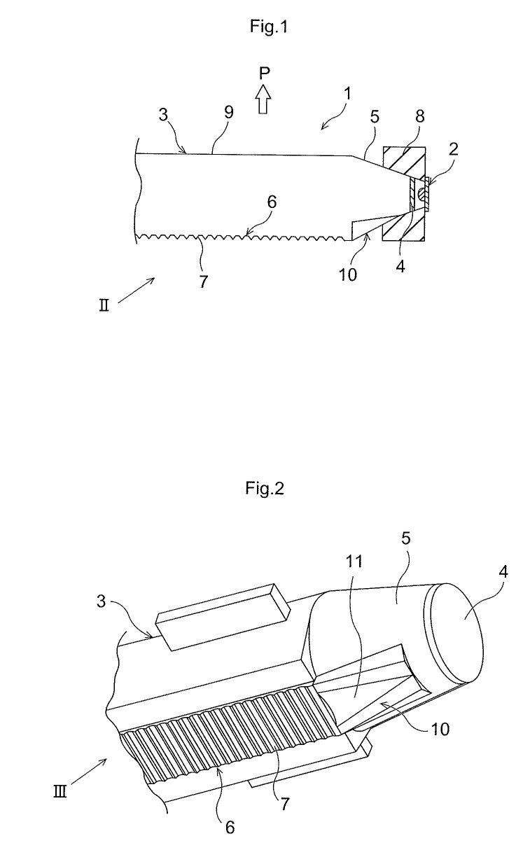

As shown in FIG. 1 and FIG. 2, a lighting apparatus 1 of the present invention has a light source 2, and a light guide body 3 that guides light generated from the light source 2 toward a surface to be scanned of a document (not shown in the drawings) located in the direction of arrow P direction.

In the light source 2, an LED chip is provided on a substrate made of ceramic, for example, and a hemispherical lens is provided to cover the LED chip. A single-chip white color LED can be utilized as the light source 2. This LED chip generates blue color light. The lens is provided or configured by dispersing a yellow color fluorescent substance in a bonding material made of transparent silicon. Blue color light generated from the LED chip is converted into yellow color light by the yellow color fluorescent substance in the lens, and white color light is formed by combining blue color light transmitting through the lens and yellow color light generated from the yellow fluorescent substance. Other types of LED chips can of course be utilized and are within the scope of the present disclosure.

The light guide body 3 is provided and sized so as to extend over substantially an entire width of the scanning area. A light reflecting portion 6 is provided to oppose a light emitting surface 9 extending in a longitudinal length of the light guide body 3, so that light generated from the light source 2 is caused to enter a light incidence portion 4 on one side of the longitudinal direction and exit from the light emitting surface 9. The light guide body 3 is made of a resin material having transmissivity such as an acrylic resin (PMMA: polymethylmethacrylate), and provided with a tapered portion 5 having a tapered shape whose cross-sectional area becomes gradually larger from the light source 2 side toward the side distant from the light source.

The light incidence portion 4 is a surface configured to cause light of the light source 2 to be radiated efficiently from the light emitting surface 9 toward a document. The light emitting surface 9 is a curved surface having an elliptical cross-section. A plurality of projected prisms 7 having a triangular or trapezoidal cross-section are arranged in a longitudinal direction of the light guide body 3 and extending in a direction perpendicular to the longitudinal direction of the light guide body 3 on a flat surface or a gradually curved surface. A light reflector 8 is provided on the light source 2 side to introduce light generated from the light source 2 into the light incidence portion 4 of the light guide body 3.

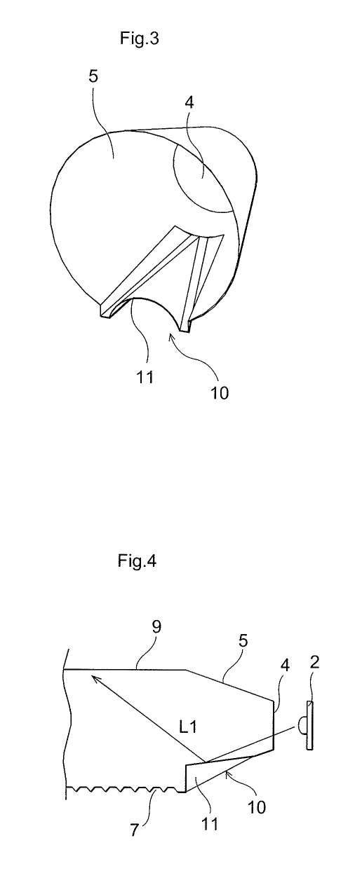

A light shielding portion 10 is provided in a part of an inner surface of the tapered portion 5 that extends from the light incidence portion 4 to the light reflecting portion 6. The light shielding portion 10 reflects incident light in a direction different from the inner surface of the tapered portion 5. With additional reference to FIG. 3, the light shielding portion 10 is formed such that a concave body 11 (when viewed from the exterior) projects into the tapered portion, the concave body 11 having an outline of a circular cone whose bottom surface is on the light reflecting portion 6 side of the tapered portion 5 and whose apex is on the light incidence portion 4 side.

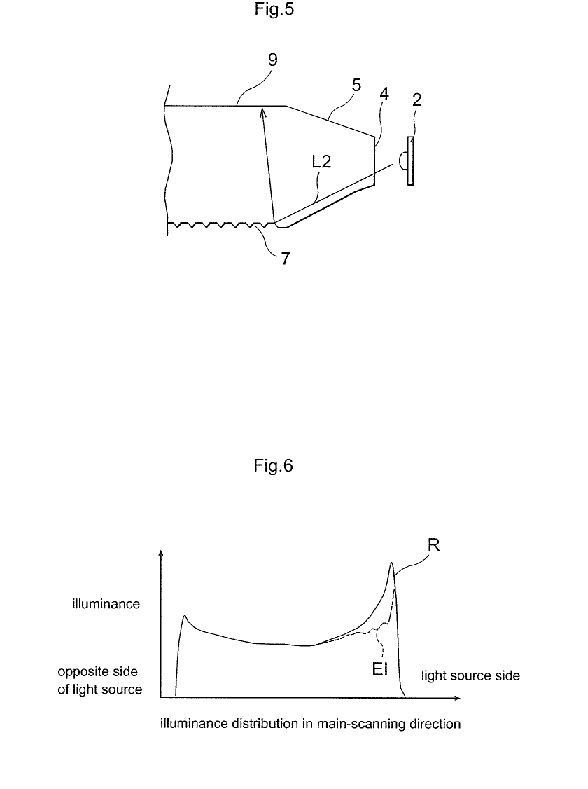

With additional reference to FIG. 4, in the present embodiment, light L1 introduced into the light guide body 3 from the light source 2 after passing through the light incidence portion 4 is reflected on the concave body 11 of the light shielding portion 10, guided in the longitudinal direction of the light guide body 3, and emitted from the light emitting surface 9 spaced from the light source 2 toward a document side. On the other hand, as shown in FIG. 5, in a reference example to which a conventional technology is applied, the direction of light L2 introduced into the light guide body 3 from the light source 2 is changed by the prism 7, and the light is emitted from the light emitting surface 9 close to the light source 2 toward a document side.

FIG. 6 shows simulation results of an illuminance distribution in the main-scanning direction of example EI illustrated in FIG. 4 and reference example R illustrated in FIG. 5. Here, the horizontal axis indicates a scanning width in the longitudinal direction of the light guide body 3 where the right side of the drawing is the light source 2 side, and the vertical axis indicates illuminance. Example EI is shown as a broken line, and reference example R is shown as a solid line. With reference to FIG. 6, in the illuminance distribution of reference example R illustrated in FIG. 5, the illuminance on a side close to the light source 2 is extremely great, and the drop of the illuminance increases with distance from the light source 2. That is, the illuminance of the light L2 is high on a side close to the light source 2 because the light path length is small and there is no attenuation.

On the other hand, in the illuminance distribution of example EI according to the present embodiment illustrated in FIG. 4, the illuminance on a side close to the light source 2 is lower than that of reference example R. This is because the concave body 11 of the light shielding portion 10 prevents the light L1 of the light source 2 from directly reaching the prism 7 close to the light source 2, and prevents the light L1, in which the light path length is small and no attenuation occurs, from being emitted from the light emitting surface 9 toward a document side.

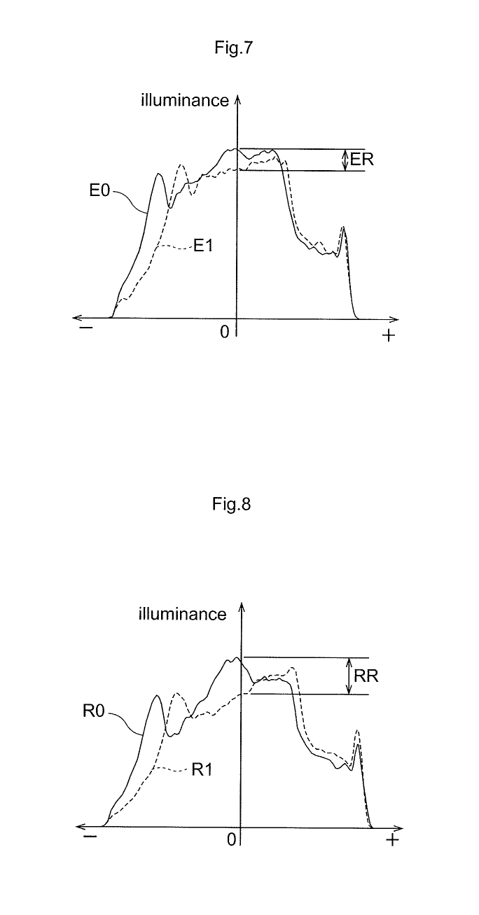

Next, with reference to FIG. 7 and FIG. 8, comparisons of example EI illustrated in FIG. 4 and reference example R illustrated in FIG. 5 will be made on simulation results of illuminance distribution in the sub-scanning direction when the distance between the lighting apparatus 1 and a document surface slightly varies. In FIG. 7 and FIG. 8, E0 and R0 refer to a case where the distance between the light emitting surface 9 and a document surface (not shown in the drawing) is as originally set, and E1 and R1 refer to a case where a document surface is further separated by 1 mm from that originally set. Here, the horizontal axis indicates a scanning width in a direction perpendicular to the longitudinal direction of the light guide body 3, and the vertical axis indicates illuminance.

First, with reference to FIG. 8 regarding reference example R, R0 reaches a peak at substantially the 0 position of the sub-scanning direction, while the peak of R1 is shifted toward a plus direction relative to the 0 position. Thus, the illuminance variation RR in the 0 position is great. Next, with reference to FIG. 7 regarding example EI, the distribution shapes of E0 and E1 are similar, and the illumination variation ER in the 0 position is smaller than the illumination distribution RR of reference example R.

In this manner, the peak can be controlled in the present embodiment as shown in FIG. 6, and the illuminance variation in the sub-scanning direction can be reduced as shown in FIG. 7 because the illumination distribution in the sub-scanning direction is leveled or evened by appropriately diffusing light within the light guide body 3. According to the simulation results, while the illuminance variation RR of reference example R is close to 20%, the illuminance variation ER of example EI can be reduced to 12%. This percentage is calculated by dividing the illuminance variation ER and RR by the illuminance E0 and R0. As described above, the present embodiment can prevent occurrence of large illuminance variation in the sub-scanning direction.

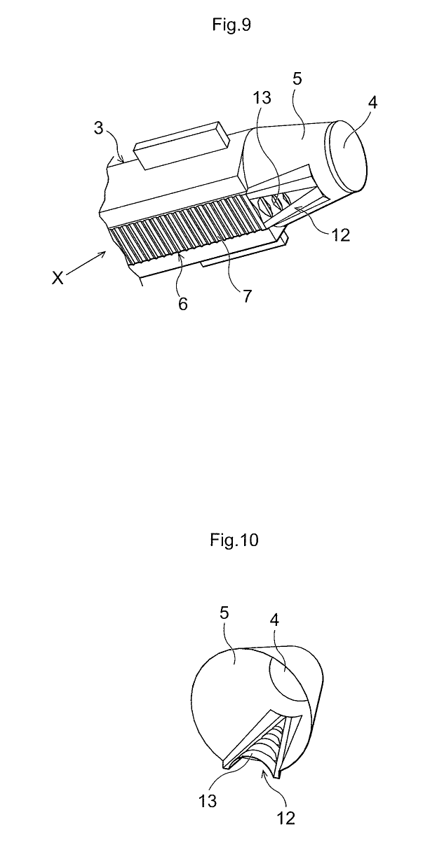

Next, with reference to FIGS. 9-11, another example of this embodiment will be explained. A light shielding portion 12 of this example EII has a different shape than the light shielding portion 10 of the above-described example EI. A plurality of prisms 13 are arranged on a surface of the concave body 11 and extend in a direction perpendicular to the longitudinal direction as shown in FIG. 10 projecting inside the tapered portion 5 shown in FIG. 3. The concave body 11 has an outline of a circular cone whose bottom surface or base is on the light reflecting portion 6 side of the tapered portion 5, and whose apex is on the light incidence portion 4 side.

With reference to FIG. 11, in example EII, light L3 introduced into the light guide body 3 from the light source 2 after passing through the light incidence portion 4 is reflected on any one of the prisms 13 arranged in the light shielding portion 12, and guided in the longitudinal direction of the light guide body 3. A reflecting surface (side of the prism 13 having a substantially trapezoidal shape on the light incidence portion 4 side) of the prism 13 has an angle suitable for causing the light L3 to be emitted from the light emitting surface spaced from the light source. In this example, in the same manner as in the above-described example, the light L3 of the light source 2 is prevented from directly reaching the prism 7 of the light reflecting portion 6 close to the light source 2, and the light L3, in which the light path length is small and no attenuation occurs, is prevented from being emitted from the light emitting surface 9 toward a document side.

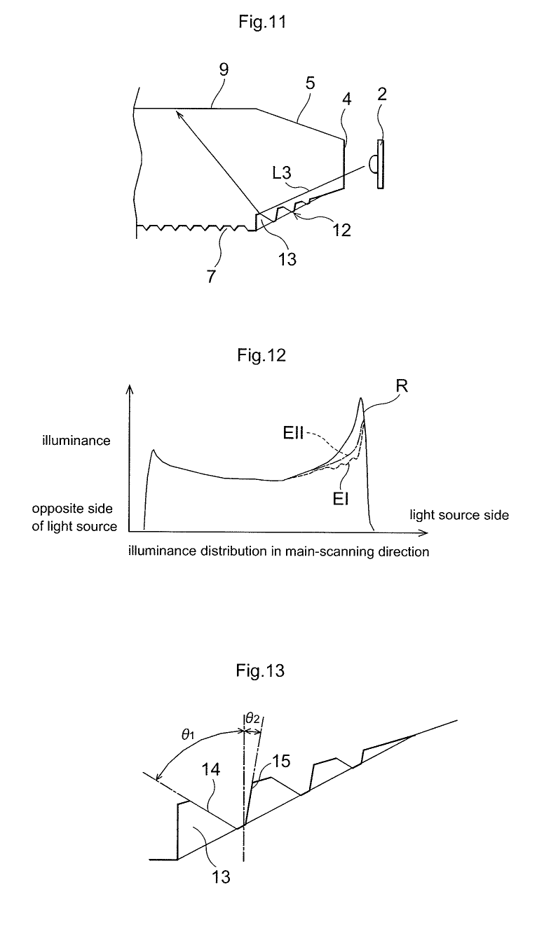

FIG. 12 is a chart where an illuminance distribution in the main-scanning direction of example EII illustrated in FIG. 11 is superimposed on illuminance distribution in the main-scanning direction of example EI illustrated in FIG. 4 and reference example R illustrated in FIG. 5. As shown in FIG. 12, the peak of the illuminance distribution of example EII is substantially similar to that of example EI, and the trajectory of example EII moving away from the light source 2 side is between example EI and reference example R. The illuminance distribution shown in FIG. 12 is that of representative examples of example EL example EII, and reference example R. A detailed explanation regarding example EII will be described later.

In example EII, by forming the prisms 13 in the light shielding portion 12, the peak of the illuminance is lowered compared to reference example R. In addition, the illuminance variation is reduced from the peak to the main-scanning direction compared to example EL and an ideal illuminance distribution is achieved. The shape of the prisms 13 can be set appropriately taking the state of the light source 2 and the light incidence portion 4 into consideration. For example, a configuration, where fine irregularities are formed by sandblasting, may be used.

Next, with reference to the drawings, a detailed explanation will be made on the effect of the cross-sectional shape of the prisms of example EII on the illuminance variation in the main-scanning direction. FIG. 13 is an enlarged view of the cross-section of the prisms 13 of FIG. 11. The plurality of substantially trapezoidal prisms 13 are arranged along the tapered portion 5. Right sides 14 of all the prisms 13 on the light incidence portion 4 side have the same angle θ₁ with respect to a direction perpendicular to the longitudinal direction. Also, left sides 15 of all the prisms 13 on the light reflecting portion 6 side have the same angle θ₂. In the following explanation, comparisons of several examples will be made on illuminance distributions in the sub-scanning direction when the angle θ₁ and the angle θ₂ vary.

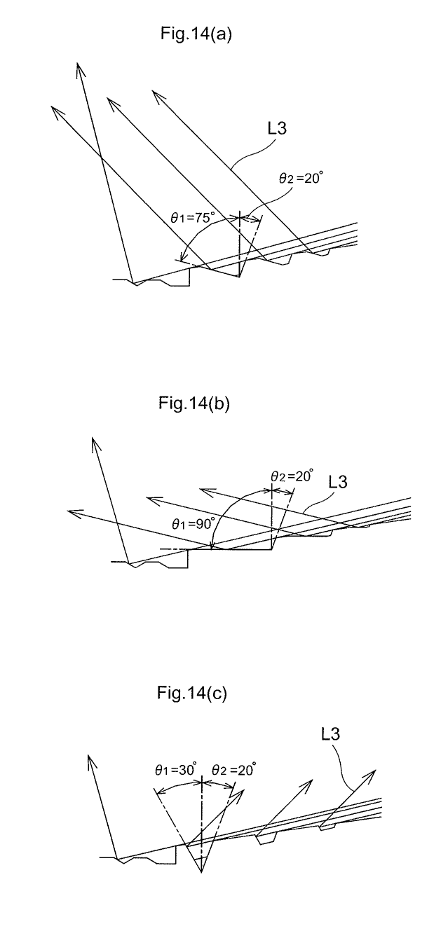

FIGS. 14(a) to 14(c) schematically illustrate the cross-sectional shape of the prisms 13 and trajectories of the light L3 introduced into the light guide body 3 from the light source 2 after passing through the light incidence portion 4 and reflected on the prisms 13. FIG. 14(a) illustrates a case of θ₁=75° and θ₂=20°, FIG. 14(b) illustrates a case of θ₁=90° and θ₂=20°, and FIG. 14(c) illustrates a case of θ₁=30° and θ₂=30°.

With reference to FIG. 14(a), the light L3 has a trajectory that is directed in the longitudinal direction of the light guide body 3 toward the light emitting surface 9. With reference to FIG. 14(b), the light L3 has a trajectory that is directed in the longitudinal direction of the light guide body 3 toward the light emitting surface 9 in the same manner as in FIG. 14(a). However, the angle with respect to the longitudinal direction of the light guide body 3 is smaller than that of FIG. 14(a). With reference to FIG. 14(c), the light L3 has a trajectory that is reflected toward the light incidence portion 4 side unlike FIG. 14(a) and FIG. 14(b).

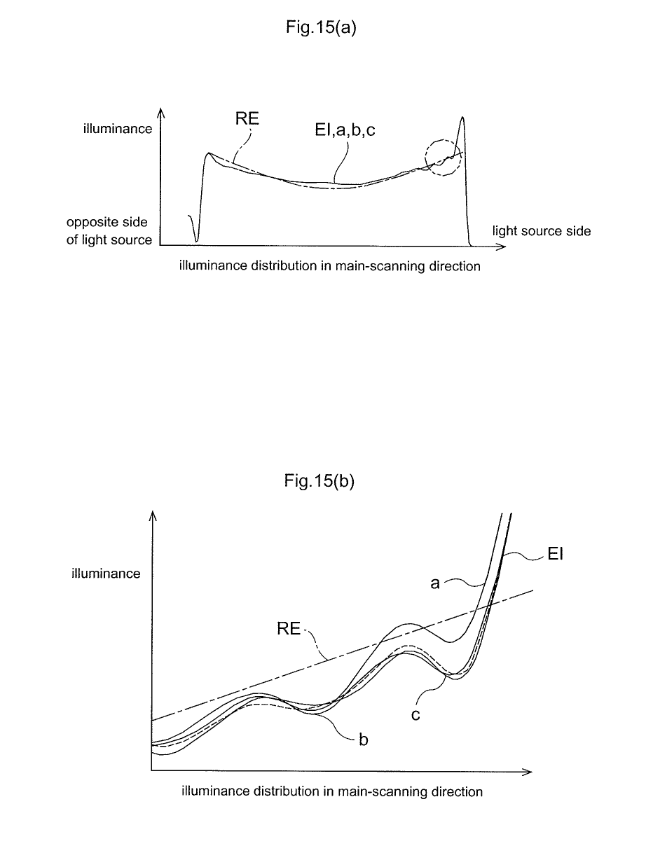

An ideal illuminance distribution is one that lowers an extreme peak of the illuminance and reduces the illumination variation from the peak to the main-scanning direction. FIGS. 15(a) and 15(b) show a comparison between illuminance distribution in the main-scanning direction of FIGS. 14(a)-14(c) and ideal illuminance distribution.

FIG. 15(a) is illuminance distribution in the main-scanning direction from the light source side to the opposite side of the light source, and FIG. 15(b) is a chart enlarging the illuminance distribution of an area in the vicinity of the light source where the illuminance variation is great (area circled by a two-dot chain line in FIG. 15(a)). Here, a trajectory RE of a chain line is ideal illuminance distribution. EI of FIG. 15(a) is the illuminance distribution of example EI illustrated in FIG. 4. “a” is the illuminance distribution of the case of θ₁=75° and θ₂=20° illustrated in FIG. 14(a), “b” is the illuminance distribution of the case of θ₁=90° and θ₂=20° illustrated in FIG. 14(b), and “c” is the illuminance distribution of the case of θ₁=30° and θ₂=20° illustrated in FIG. 14(c).

With reference to FIG. 15(a), the illuminance distribution by the prisms 13 of example EI and FIGS. 14(a)-14(c) is substantially similar in the area other than the vicinity of the light source. With reference to FIG. 15(b), illuminance distribution “a” (θ₁=75° and θ₂=20°) by the prisms 13 of FIG. 14(a) has a trajectory close to the ideal trajectory RE. However, illuminance distribution “b” (θ₁=90° and θ₂=20°) and “c” (θ₁=30° and θ₂=20° by the prisms 13 of FIG. 14(b) and FIG. 14(c) are lower than the trajectory RE in an area spaced from the light source, and show a sharp rise in an area close to the light source compared to “a”. It should be noted that illuminance distribution “b” and “c” have a similar trajectory to example EI, and are closer to the ideal trajectory RE than reference example R illustrated in FIG. 6.

With reference back to FIG. 14, in FIG. 14(a), the light L3 reflected on the prisms 13 has a reflection angle with respect to the longitudinal direction of the light guide body 3 so as to reach the light emitting surface 9 slightly spaced from the light source side of the light guide body 3. On the other hand, in FIG. 14(b), the reflected light of the light L3 reaches the light emitting surface 9 farther than in FIG. 14(a). In FIG. 14(c), the reflected light of the light L3 is directed toward the light incidence portion 4 side. In this manner, the cross-sectional shape of the prisms 13 according to FIGS. 14(a) (θ₁=75° and θ₂20°) can make reflected light close to the ideal trajectory RE. Thus, it is preferable compared to the prisms 13 of FIGS. 14(b) (θ₁=90° and θ₂=20°) and FIGS. 14(c) (θ₁=30° and θ₂=20°).

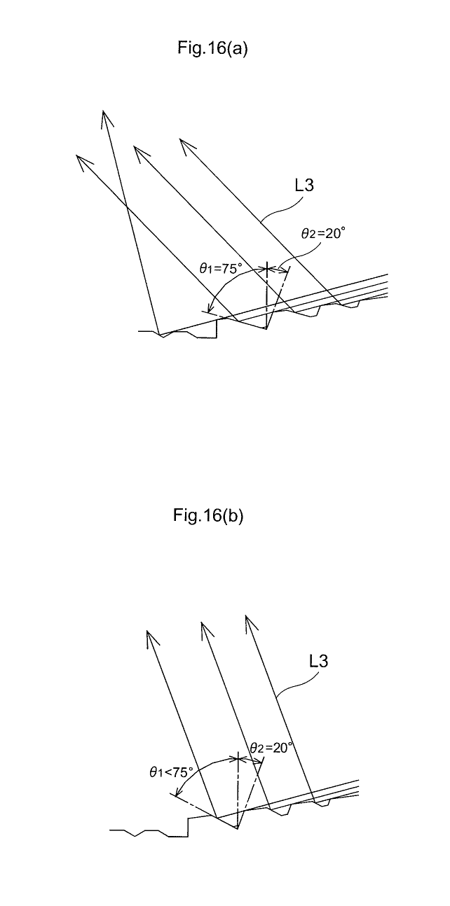

Next, FIGS. 16(a) and 16(b) schematically illustrate the cross-sectional shape of the prisms 13 and trajectories of the light L3 introduced into the light guide body 3 from the light source 2 after passing through the light incidence portion 4 and reflected on the prisms 13. FIG. 16(a) illustrates a case of θ₁=75° and θ₂=20°, and FIG. 16(b) illustrates a case of θ₁≦74° and θ₂=20°.

An explanation on FIG. 16(a) is omitted because FIG. 16(a) is similar to FIG. 14(a). With reference to FIG. 16(b), the light L3 has a trajectory that is directed in the longitudinal direction of the light guide body 3 toward the light emitting surface 9 in the same manner as in FIG. 16(a). However, the angle with respect to the longitudinal direction of the light guide body 3 is greater than that of FIG. 16(a).

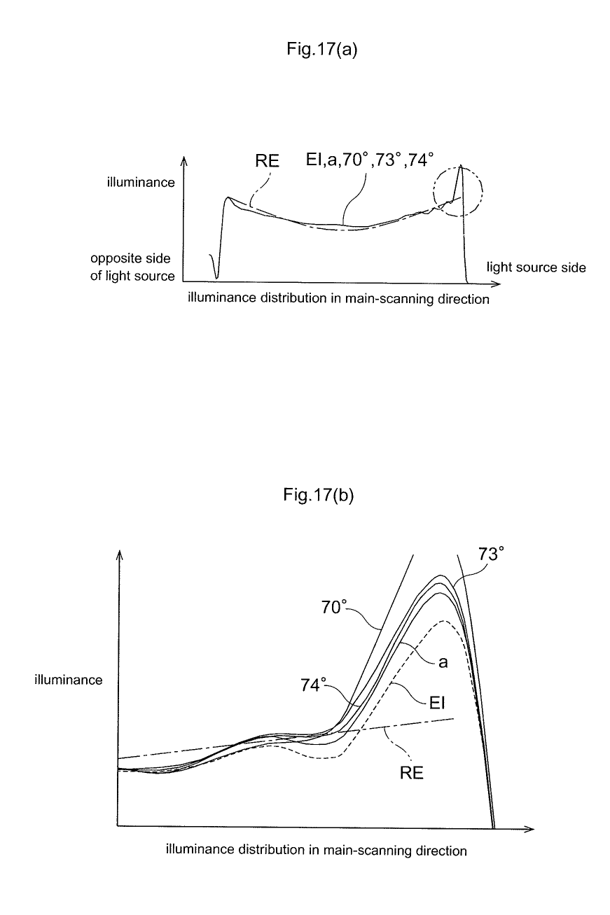

FIGS. 17(a) and 17(b) show a comparison between illuminance distribution in the main-scanning direction of FIG. 16(a) and FIG. 16(b), and ideal illuminance distribution. FIG. 17(a) is an illuminance distribution in the main-scanning direction from the light source side to the opposite side of the light source, and FIG. 17(b) is a chart enlarging the illuminance distribution of an area in the vicinity of the light source where the illuminance variation is great (area circled by a two-dot chain line in FIG. 17(a)). Here, a trajectory RE of a chain line is ideal illuminance distribution. EI of FIG. 17(a) is illuminance distribution of example EI illustrated in FIG. 4. Illuminance distribution “a” is of the case of θ₁=75° and θ₂=20° illustrated in FIG. 16(a). Also, illuminance distribution of the cases of θ₁=70°, 73° and 74°, and θ₂=20° as the cross-sectional shape of the prisms 13 according to FIG. 16(b) is illustrated.

With reference to FIG. 17(a), illuminance distribution by the prisms 13 of FIG. 16(a) and FIG. 16(b) is substantially similar in the area other than the vicinity of the light source. With reference to FIG. 17(b), as θ₁ becomes smaller than 74° in the cross-sectional shape of the prisms 13 of FIG. 16(b), the peak of the illuminance in the vicinity of the light source becomes high compared to illuminance distribution “a” (θ₁=75° and θ₂=20°) of the prisms 13 of FIG. 16(a). The distribution is spaced from the ideal trajectory RE.

With reference back to FIGS. 16(a) and 16(b), in FIG. 16(a), the light L3 reflected on the prisms 13 has a reflection angle with respect to the longitudinal direction of the light guide body 3 so as to reach the light emitting surface 9 slightly spaced from the light source side of the light guide body 3. On the other hand, in FIG. 16(b), the reflected light of the light L3 is directed toward the light emitting surface 9 closer to the light source than in FIG. 16(a). However, the peak is not extremely high except for the case of θ₁=70°, and there is a tendency to get close to the ideal trajectory RE. Thus, the cross-sectional shape of the prisms 13 where θ₁ is 75° according to FIG. 16(a), and the cross-sectional shape of the prisms 13 where θ₁ is 73° and 74° are preferable compared to the case where θ₁ is 70°.

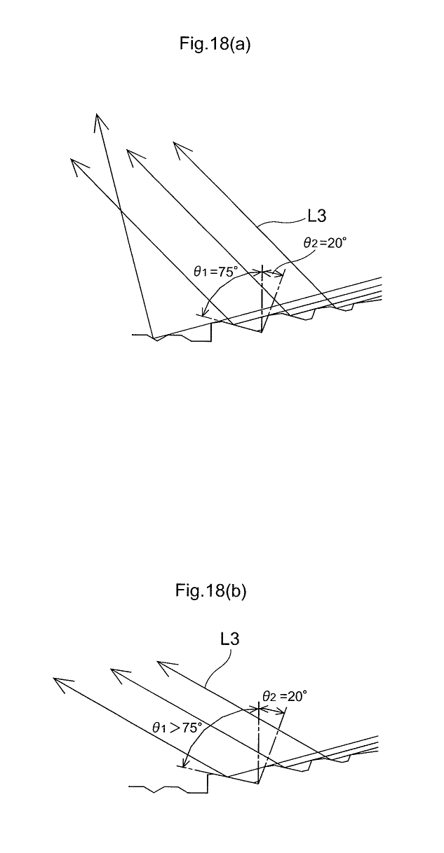

Next, FIGS. 18(a) and 18(b) schematically illustrate the cross-sectional shape of the prisms 13 and trajectories of the light L3 introduced into the light guide body 3 from the light source 2 after passing through the light incidence portion 4 and reflected on the prisms 13. FIG. 18(a) illustrates a case of θ₁=75° and θ₂=20 °, and FIG. 18(b) illustrates a case of θ₁≧76°.

An explanation on FIG. 18(a) is omitted because FIG. 18(a) is similar to FIG. 14(a). With reference to FIG. 18(b), the light L3 has a trajectory that is directed in the longitudinal direction of the light guide body 3 toward the light emitting surface 9 in the same manner as in FIG. 18(a). However, the angle with respect to the longitudinal direction of the light guide body 3 is smaller than that of FIG. 18(a).

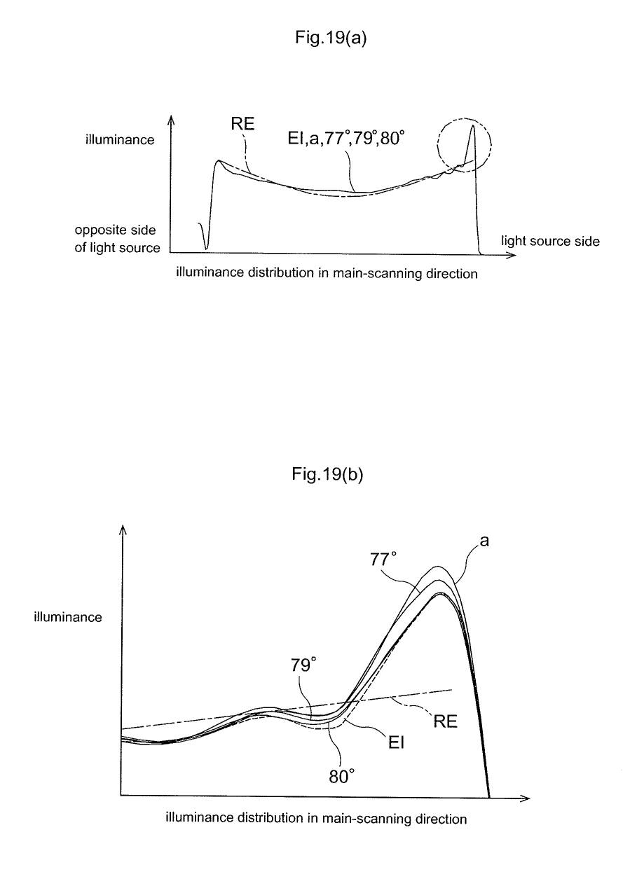

FIGS. 19(a) and 19(b) show a comparison between illuminance distribution in the main-scanning direction of FIG. 18(a) and FIG. 18(b), and ideal illuminance distribution. FIG. 19(a) is illuminance distribution in the main-scanning direction from the light source side to the opposite side of the light source, and FIG. 19(b) is a chart enlarging the illuminance distribution of an area in the vicinity of the light source where the illuminance variation is great (area circled by a two-dot chain line in FIG. 19(a)). Here, a trajectory RE of a chain line is the ideal illuminance distribution. EI of FIG. 19(a) is illuminance distribution of example El illustrated in FIG. 4. Illuminance distribution “a” is of the case of θ₁=75° and θ₂=20° illustrated in FIG. 18(a). Also, illuminance distribution of the cases of θ₁=77°, 79° and 80°, and θ₂=20° as the cross-sectional shape of the prisms 13 according to FIG. 18(b) is illustrated.

With reference to FIG. 19(a), illuminance distribution by the prisms 13 of FIG. 18(a) and FIG. 18(b) is substantially similar in the area other than the vicinity of the light source. With reference to FIG. 19(b), as θ₁ becomes greater than 77° in the cross-sectional shape of the prisms 13 of FIG. 18(b), the peak of the illuminance distribution in the vicinity of the light source becomes low compared to illuminance distribution “a” (θ₁=75° and θ₂=20° of the prisms 13 of FIG. 18(a). The distribution is lower than the ideal trajectory RE in accordance with distance from the light source side. However, the illuminance distribution is closer to the ideal trajectory RE than reference example R illustrated in FIG. 6.

As described above, it is preferable that θ₁ of the prisms 13 is appropriately selected to achieve desired illuminance distribution as long as θ₁ is within a range of 73°-80°.

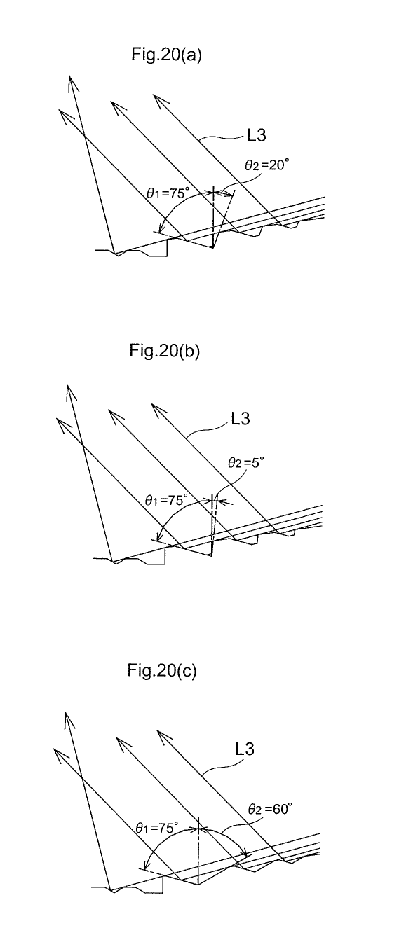

Next, FIGS. 20(a) to 20(c) schematically illustrate the cross-sectional shape of the prisms 13 and trajectories of the light L3 introduced into the light guide body 3 from the light source 2 after passing through the light incidence portion 4 and reflected from the prisms 13. FIG. 20(a) illustrates a case of θ₁=75° and θ₂=20°, FIG. 20(b) illustrates a case of θ₁=75° and θ₂=5°, and FIG. 20(c) illustrates a case of θ₁=75° and θ₂=60°.

An explanation on FIG. 20(a) is omitted because FIG. 20(a) is similar to FIG. 14(a). With reference to FIG. 20(b) and FIG. 20(c), the light L3 has a trajectory that is directed in the longitudinal direction of the light guide body 3 toward the light emitting surface 9 in the same manner as in FIG. 20(a).

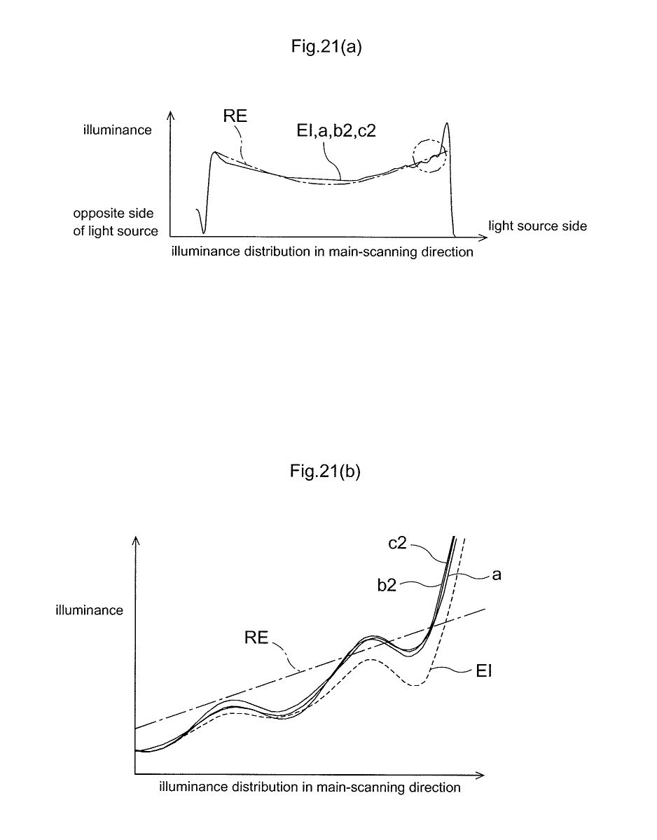

FIGS. 21(a) and 21(b) show a comparison between illuminance distribution in the main-scanning direction of FIGS. 20(a)-20(c), and ideal illuminance distribution. FIG. 21(a) is illuminance distribution in the main-scanning direction from the light source side to the opposite side of the light source, and FIG. 21(b) is a chart enlarging the illuminance distribution of an area in the vicinity of the light source where the illuminance variation is great (area circled by a two-dot chain line in FIG. 21(a)). Here, a trajectory RE of a chain line is the ideal illuminance distribution. EI of FIGS. 21(a) and 21(b) is the illuminance distribution of example EI illustrated in FIG. 4. Illuminance distribution “a” is of the case of θ₁=75° and θ₂=20° illustrated in FIG. 20(a). Illuminance distribution “b2” is of the case of θ₁=75° and θ₂=5° illustrated in FIG. 20(b). Illuminance distribution “c2” is of the case of θ₁=75° and θ₂=60° illustrated in FIG. 20(c).

With reference to FIG. 21(a), illuminance distribution by the prisms 13 of FIGS. 20(a)-20(c) is substantially similar in the area other than the vicinity of the light source. Similarly, with reference to FIG. 21(b), illuminance distribution by the prisms 13 of FIGS. 20(a)-20(c) is substantially similar. Thus, θ₂ of the prisms 13 is not limited to a particular value.

As described above, according to the present embodiment, it is possible to achieve ideal illuminance distribution by appropriately selecting the cross-sectional shape of the prisms 13.

Second Embodiment

Next, a second embodiment of the present invention will be explained with reference to the drawings. According to the present embodiment, the shape of the light incidence portion 4 of the first embodiment (see FIG. 1 etc.) is changed to control occurrence of illuminance ripple.

When a light source of a lighting apparatus is mounted, the position relationship between the light guide body and the light source might be slightly displaced within the assembly tolerance of various parts. The possible reasons for this include mounting accuracy of an LED to a substrate, dividing accuracy of the substrate where the LED is mounted, placing accuracy of the LED base to a lighting apparatus fixture, fixing accuracy of the light guide body, size accuracy of each part, and the like. Eventually, displacement between the axis of the light guide body and the axis of the light source is within +0.3 mm. This displacement, however, makes it difficult to smoothly shift the illuminance from high illuminance area closest to the light source toward the low illuminance area spaced from the light source, which causes illuminance ripple that is a sharp illuminance variation especially in the area close to the light source. Therefore, there is a likelihood that illuminance ripple will make the sensitivity in the main-scanning direction non-uniform at the time of scanning a document.

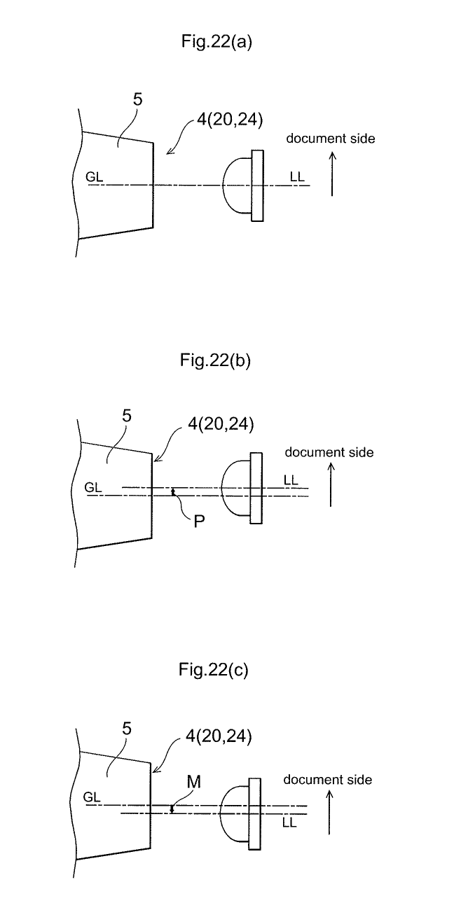

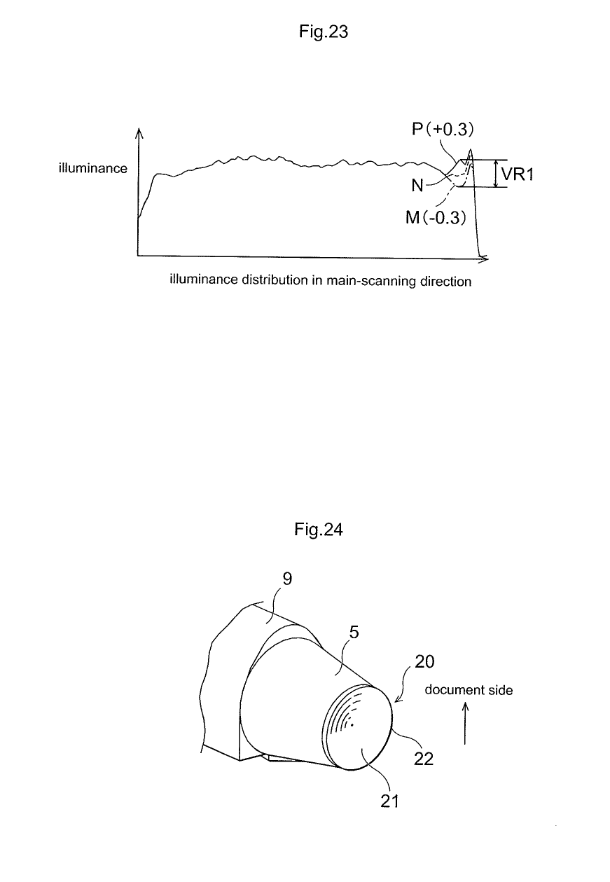

FIGS. 22(a) to 22(c) show a status of displacement between the light guide body axis GL and the light source axis LL. FIG. 22(a) illustrates a case where there is no axis displacement. FIG. 22(b) illustrates a case where the light source axis LL is displaced with respect to the light guide body axis GL by a displacement P toward a direction of a document side. FIG. 22(c) illustrates a case where the light source axis LL is displaced with respect to the light guide body axis GL by a displacement M toward a direction opposite to a document side. FIG. 23 illustrates simulation results of illuminance distribution in the main-scanning direction corresponding to each of FIGS. 22(a)-22(c), when the light incidence portion 4 shown in FIG. 1 is formed to be a flat surface. The displacement of P is plus 0.3 mm, and the displacement of M is minus 0.3 mm. When there is no displacement, N represents the illuminance distribution.

With reference to FIG. 23, line segments N, P and M have different trajectories on the side close to the light source (right side in the drawing). Regarding the line segment P, the decline from a mountain-shaped peak on the right side in the drawing is small, and there is another decline after another small mountain-shaped peak. The line segment P then overlaps the other line segments N and M. The line segment M drastically falls from a mountain-shaped peak on the right side in the drawing, passes through a valley-shaped region, and thereafter rises and overlaps the line segments N and P. The line segment N gradually falls between the line segment P and the line segment M, and overlaps the line segments P and M.

According to the simulation results, the greatest difference VR1 between the line segment P and the line segment M is approximately 7500 lux, which causes illuminance ripple that is sharp illuminance variation in the illuminance distribution close to the light source. Thus, when the light incidence portion 4 is formed to be a flat surface, there is a likelihood that illuminance ripple will make the sensitivity in the main-scanning direction non-uniform at the time of scanning a document.

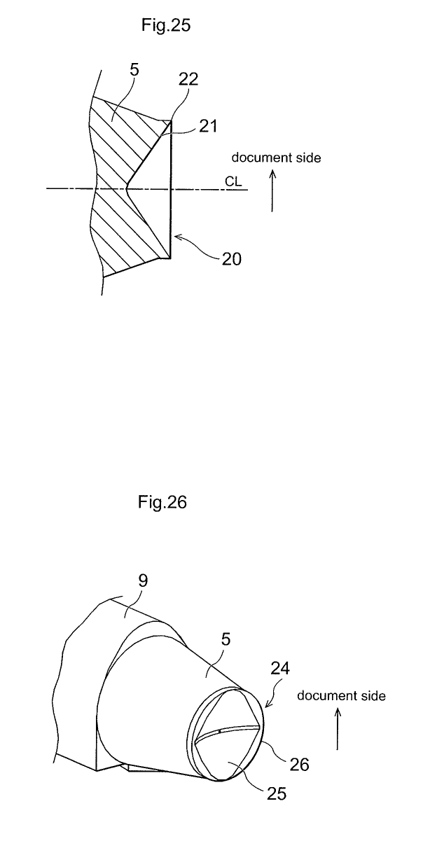

According to the present embodiment, the shape of the light incidence portion 4 of the first embodiment (see FIG. 1 etc.) is changed. With reference to FIG. 24 and FIG. 25, a light incidence portion 20 of an example of the present embodiment has an edge 22 in a circular shape and a concave surface 21 in the center. The concave surface 21 is an outline of a circular cone whose bottom or base surface is a circle that includes the edge 22 and which faces the longitudinal direction of the light guide body 3.

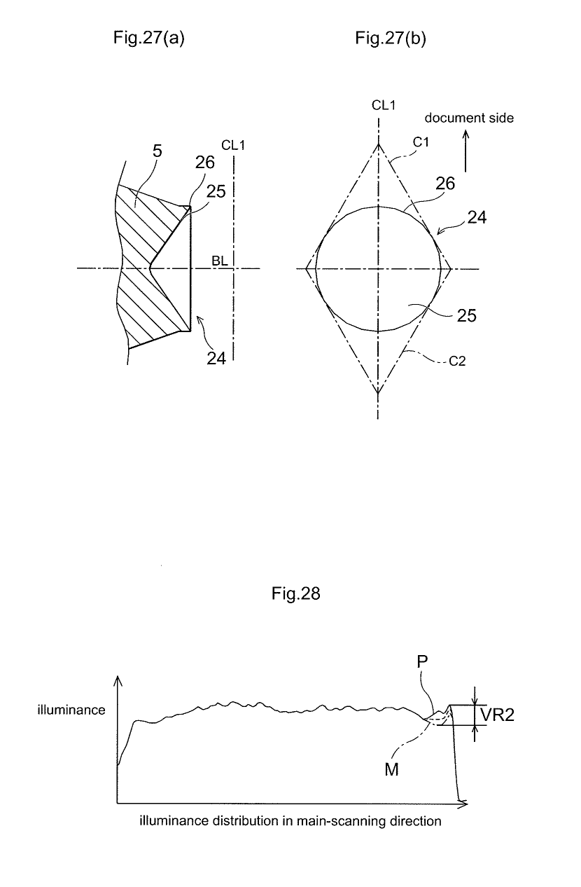

Also, with reference to FIG. 26 and FIG. 27, a light incidence portion 24 of another example of the present embodiment has an edge 26 in a substantially circular shape and a concave surface 25 in the center. The concave surface 25 is a part of a side surface of a bicone having upper and lower apexes. Specifically, when a vertical direction from the light reflecting portion 6 to the light emitting surface 9 is defined as a first direction and a horizontal direction perpendicular to the first direction is defined as a second direction, the concave surface 25 is configured to be a part of outer side surfaces of circular cones C1 and C2, whose bottom surfaces are a horizontal plane including a second axis BL that extends the second direction of the light incidence portion 24, and which are located on a line connecting the light incidence portion 24 and the light source 2. The circular cones C1 and C2 are formed by rotation around a first axis CL1 parallel to an axis that extend along the first direction along the edge 26 of the light incidence portion 24, and extend above and below the bottom surfaces.

As explained in FIG. 23, when displacement occurs between the axis of the light guide body and the axis of the light source in a case where the light incidence portion is a flat surface, illuminance ripple occurs corresponding to the displacement as shown in the simulation results. On the other hand, in the examples of the present embodiment shown in FIGS. 24-27, illuminance ripple is reduced by changing a refraction state and a reflection state when incident light passes through the light incidence portion.

Specifically, light that reaches a surface far from the light source passes through the light incidence surface where refraction is small, is reflected on a prism close to the light source of the light guide body, and is emitted from the light emitting surface in the vicinity of the light source. Further, light reflected on the surface far from the light source can be directed toward the light emitting surface in the vicinity of the light source by the inclination of the surface, and thereby a drop of the illuminance shown in the line segment M of FIG. 23 is reduced. On the other hand, light that reaches a surface close to the light source passes through the light incidence surface where refraction is great, is reflected on a prism spaced from the light source of the light guide body, and is emitted from the light emitting surface spaced from the light source. Further, light reflected on the surface close to the light source can be directed toward the light emitting surface spaced from the light source by the inclination of the surface, and thereby a rise of the illuminance shown in the line segment P of FIG. 23 is reduced.

For example, when displacement occurs in the P direction as shown in FIG. 22(b), the illuminance of light incident upon the upper side with respect to CL of FIG. 25 and BL of FIGS. 27(a) and 27(b) becomes deteriorated in the light emitting surface in the vicinity of the light source by refraction or reflection. Thus, it is possible to control the mountain-shaped peak of the line segment P that constitutes the greatest difference VR1 of FIG. 23. Also, the illuminance of light incident upon the lower side with respect to CL of FIG. 25 and BL of FIG. 27(a) is increased in the light emitting surface in the vicinity of the light source by refraction or reflection. Thus, the illuminance of the line segment P on the side spaced from the light source of FIG. 23 tends to be increased, and variation resulting from the mountain-shaped peak is reduced.

Similarly, when displacement occurs in the M direction as shown in FIG. 22(c), the illuminance of light incident upon the upper side with respect to CL of FIG. 25 and BL of FIG. 27(a) is increased in the light emitting surface in the vicinity of the light source by refraction or reflection. Thus, it is possible to control the valley-shaped section of the line segment M that constitutes the greatest difference VR1 of FIG. 23. Also, the illuminance of light incident upon the lower side with respect to CL of FIG. 25 and BL of FIG. 27(a) is reduced in the light emitting surface in the vicinity of the light source by refraction or reflection. Thus, the illuminance of the line segment M on the side spaced from the light source of FIG. 23 tends to be reduced, and variation resulting from the valley-shaped section is reduced.

As described above, according to the present embodiment, even in a case where displacement occurs between the axis of the light guide body and the axis of the light source, illuminance ripple is controlled by leveling the luminous divergence.

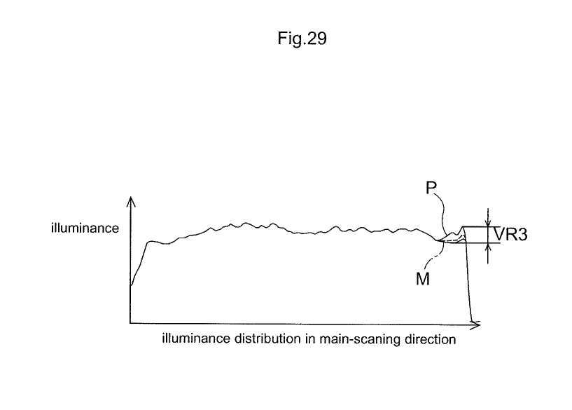

FIG. 28 shows simulation results of illuminance distribution of the example according to FIG. 24 and FIG. 25. FIG. 29 shows simulation results of illuminance distribution of the example according to FIG. 26 and FIG. 27. In FIG. 28, the greatest difference VR2 between the line segment P and the line segment M is approximately 3500 lux. In FIG. 29, the greatest difference VR3 between the line segment P and the line segment M is approximately 1360 lux. Both are smaller than approximately 7500 lux of the case where the light incidence portion of FIG. 23 is a flat surface, which makes it possible to significantly control the illuminance ripple.

Especially, in the example according to FIG. 26 and FIG. 27, by providing outer side surfaces of circular cones C1 and C2 above and below the bottom surfaces including the second axis BL, it is possible to effectively change the refraction state when incident light passes through the light incidence portion, and significantly reduce the illuminance ripple.

Although two examples are explained in the present embodiment, the present invention is not limited to these examples. Other than these, for example, it may be possible to arrange a part around the apex of the circular cone of the concave portion 21 in FIG. 25 to have a curvature, slightly extend the edge 22 or the edge 26 in a cylindrical shape, or set or determine the shape of the concave portion based on simulation results of refraction or reflection of the incident light.

Also, according to the present embodiment, by forming the concave portion 21, 25 in the light incidence portion 20, 24, a distance can be provided between the light source and the light incidence portion 20, 24. With this configuration, since a space is formed between the light source and the light guide body, it is possible to avoid a problem such as softening of the light guide body due to heat generation of the LED used as the light source. Further, the present embodiment can achieve a light guide body which controls more illuminance variation by being combined with the first embodiment and a lighting apparatus that has the light guide body.

The light guide body and the lighting apparatus of the present invention are useful as a light guide body that extends in a main-scanning direction to illuminate a document in a document scanning apparatus and the like to scan an image of a document surface in which the occurrence of large illuminance variation is prevented and occurrence of illuminance ripple is prevented and a lighting apparatus that has the light guide body.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention. Further, it is within the scope of the present invention that features and aspects of the examples and embodiments disclosed here can be combined.

What is claimed is:

1. A light guide body comprising:
a light incidence portion through which light enters the light guide body;
a light reflecting portion positioned opposite a light emitting surface that extends from the light incidence portion in a longitudinal direction of the light guide body; and
a tapered portion having an inner surface that gradually expands from the light incidence portion toward the light reflecting portion and that has a light shielding portion to shield, from the light, a part of the light reflecting portion closest to the light incidence portion.

2. The light guide body according to claim 1, wherein the light shielding portion is a concave portion provided in an inner surface of the tapered portion.

3. The light guide body according to claim 2, wherein the concave portion is a part of a side surface of a cone.

4. The light guide body according to claim 3, wherein an apex of the cone is on the light incidence portion side and a bottom surface of the cone is on the light reflecting portion side.

5. The light guide body according to claim 3, wherein the cone is a circular cone.

6. The light guide body according to claim 2, wherein the convex portion is provided with a plurality of prisms spaced along the longitudinal direction of the tapered portion, and each of the prisms projects into the tapered portion and has a projection shape that extends in a direction perpendicular to the longitudinal direction.

7. The light guide body according to claim 6, wherein each of the prisms has a substantially trapezoidal shape.

8. The light guide body according to claim 7, wherein a side of each one of the prisms on the light incidence portion side has an angle within a range of between 73° and 80° with respect to a direction perpendicular to the longitudinal direction.

9. The light guide body according to claim 1, wherein an incidence surface of the light incidence portion is a concave surface.

10. The light guide body according to claim 9, wherein the concave surface is an outline of a cone that faces the longitudinal direction of the light guide body.

11. The light guide body according to claim 10, wherein the cone is a circular cone.

12. The light guide body according to claim 10, wherein a part around the apex of the cone has a curvature.

13. The light guide body according to claim 9, wherein the concave surface is a part of a side surface of a bicone having apexes one above the other.

14. The light guide body according to claim 2, wherein the concave portion is provided in a region of the tapered portion extending towards the light reflecting portion.

15. The light guide body according to claim 7, wherein a length of the prisms, in a direction perpendicular to the longitudinal direction, increases in accordance with distance from the light incidence portion.

16. The light guide body according to claim 1, wherein the light shielding portion is configured to distribute incident light along a longitudinal length of the light guide body.

17. A light guide body comprising:
a light incidence portion through which light from a light source enters the light guide body;
a light reflecting portion positioned opposite a light emitting surface of the light guide body and that extends from the light incidence portion in a longitudinal direction of the light guide body; and
a tapered portion that extends from the light incidence portion towards the light reflecting portion, the tapered portion becoming larger in accordance with distance from the light incident portion,
wherein the light incidence portion having a surface configured to control an occurerence of illuminance ripple resulting from a misalignment between a longitudinal axis of the light guide body and an axis of the light source.

18. The light guide body according to claim 17, wherein the surface of the light incidence portion comprises a concave surface.

19. The light guide body according to claim 17, wherein the tapered portion comprising a light shielding portion that shields, from the light, a part of the light reflecting portion closest to the light incident portion.

20. A lighting apparatus comprising the light guide body according to claim 1.
